(19) United States
(12) Patent Application Publication
(10) Pub. No.: US 2008/0002741 A1
(43) Pub. Date: Jan. 3, 2008

(54) Apparatus, method and computer program product providing optimized location update for mobile station in a relay-based network

(75) Inventors: Shashikant Maheshwari, Irving, TX (US); Yousuf Saifullah, Richardson, TX (US)

Correspondence Address: HARRINGTON & SMITH, PC, 4 RESEARCH DRIVE, SHELTON, CT, 06484-6212, US

(73) Assignee: Nokia Corporation

(21) Appl. No.: 11/479,171

(22) Filed: Jun. 30, 2006

(51) Int. Cl. H04Q 7/00; H04J 3/24

(52) U.S. Cl. 370/473; 370/328

(57) ABSTRACT

A relay node receives individual ones of a plurality of request messages destined for a network access node from individual ones of a plurality of user nodes; aggregates the received individual ones of the plurality of request messages into a single message at the relay node; and sends the single message to the network access node. The relay node further operates to receive from the network access node a single message that contains an aggregated plurality of response messages for individual ones of the user nodes and sends individual ones of the response messages to individual ones of the user nodes. The method advantageously handles the case of a mobile relay node, having a plurality of attached idle state mobile stations/subscriber stations, that transitions to a new paging group.

### TECHNICAL FIELD

The teachings in accordance with the exemplary embodiments of this invention relate generally to wireless communications networks, devices, methods and computer program products and, more specifically, relate to those networks that include a relay node.

### BACKGROUND

The following abbreviations are defined as follows:
RS Relay Station
BS Base Station
MS Mobile Station
SS Subscriber Station
AP Access Point
CDMA Code Division Multiple Access
LU Location Update
PG Paging Group
PC Paging Controller
DCD Downlink Channel Descriptor
DL Downlink (BS towards MS via RS)
UL Uplink (MS towards BS via RS)

As wireless technology has advanced, a variety of wireless networks have been installed, such as cellular and other wireless networks. Some wireless networks are based upon the Institute of Electrical and Electronics Engineers (IEEE) 802.11 family of Wireless LAN (WLAN) industry specifications. Other wireless technologies are being developed, such as IEEE 802.16, also referred to as WiMax, industry specifications. IEEE 802.16 defines the wireless air interface specification for wireless metropolitan area networks. A number of working groups are engaged in efforts to improve on this technology. In WiMAX or in general other cellular-type wireless systems, the MS belongs to one PAGING_GROUP area. Similarly the BS also belongs to one (or more) PAGING_GROUP(s). A PAGING_GROUP ID that identifies a particular PAGING_GROUP is transmitted on a broadcast channel (in WiMAX, it is transmitted on a DCD and/or MOB_PAG_ADV message). The MS monitors these messages (MOB_PAG_ADV message is transmitted according to MS PAGING_CYCLE and PAGING OFFSET). When the MS moves from one PAGING_GROUP area to another PAGING_GROUP area, it initiates a location update procedure. As per the current specification of IEEE802.16 (IEEE802.16-2004 and IEEE802.16e-2005), the location update procedure is performed between the MS and the BS.

A wireless relay network is a multi-hop system in which end nodes (e.g., MS/SSs) are connected to the BS or AP via a RS. All traffic between the end nodes and the BS/AP passes through, and is processed by, the RS. One non-limiting example of a relay network is currently under discussion for 802.16 Mobile Multi-hop Relay (MMR), which is a task group 802.16j. The MMR work focuses on defining a network system that uses RSs to extend the network coverage and/or to enhance the system throughput.

As may be appreciated, if the RS is itself mobile, such as by being installed on a mobile platform such as a vehicle (a terrestrial vehicle, a water-based vehicle, or an airborne vehicle), the mobility of the RS with respect to the BS and the MS (or SS) adds an additional level of system complexity. In practice, a given RS may have numerous MSs attached to it at any given time. If the RS moves out of one location area (defined by a Paging Group) to another location area (defined by another Paging Group), this event will trigger location update signaling for all of the idle state MSs attached to the mobile RS. This event would thus abruptly increase the signaling message load and increase overall congestion in the system since all idle state MSs will essentially simultaneously perform the location update procedure, which involves a bidirectional signaling message flow, via the RS, between the BS and the affected idle state MSs.

### SUMMARY OF THE EXEMPLARY EMBODIMENTS

The foregoing and other problems are overcome, and other advantages are realized, in accordance with the non-limiting and exemplary embodiments of this invention.

In accordance with an exemplary aspect thereof the embodiments of this invention provide a method that includes operating a relay node to receive individual ones of a plurality of request messages destined for a network access node from individual ones of a plurality of user nodes; aggregating the received individual ones of the plurality of request messages into a single message at the relay node; and sending the single message to the network access node.

Further in accordance with an exemplary aspect thereof the embodiments of this invention provide a computer program product embodied on a computer readable medium and comprising program instructions the execution of which by a data processor of a relay node result in operations that comprise receiving individual ones of a plurality of request messages destined for a network access node from individual ones of a plurality of user nodes; aggregating the received individual ones of the plurality of request messages into a single message at the relay node; and sending the single message to the network access node.

In accordance with another exemplary aspect thereof the embodiments of this invention provide a relay node that comprises at least one wireless transceiver to conduct communications with a network access node and with user nodes. The relay node further comprises a control unit coupled to the wireless transceiver and operable to receive individual ones of a plurality of request messages destined for the network access node from individual ones of a plurality of user nodes, to aggregate the received individual ones of the plurality of request messages into a single message and to transmit the single message to the network access node.

In accordance with another exemplary aspect thereof the embodiments of this invention provide a method that includes operating a network access node to receive a message from a relay node, the message comprising a plurality of request messages destined for a network access node that are sent individually from individual ones of a plurality of user nodes and, in response, aggregating a plurality of response messages for individual ones of the user nodes and sending the aggregated plurality of response messages to the relay node.

In accordance with yet another exemplary aspect thereof the embodiments of this invention provide a computer program product embodied on a computer readable medium and comprising program instructions the execution of which by a data processor of a network access node result in operations that comprise receiving a message from a relay node, the message comprising a plurality of request messages destined for the network access node that are sent individually from individual ones of a plurality of user nodes and, in response, aggregating a plurality of response messages for individual ones of the user nodes and sending the aggregated plurality of response messages to the relay node.

In accordance with a further exemplary aspect thereof the embodiments of this invention provide a network access node that comprises at least one wireless transceiver to conduct communications with a relay node that is wirelessly coupled to a plurality of user nodes, and a control unit coupled to the wireless transceiver. The control unit is operable to receive a message transmitted from the relay node, the message comprising a plurality of request messages destined for the network access node that are transmitted individually from individual ones of the plurality of user nodes and, in response, to aggregate a plurality of response messages for individual ones of the user nodes and to transmit the aggregated plurality of response messages to the relay node.

In accordance with yet another exemplary aspect thereof the embodiments of this invention provide a method that includes detecting at a relay node a change in location due to mobility of the relay node relative to at least one network access node; in response, sending location update-related information to a plurality of attached idle state user nodes; receiving and aggregating at the relay node a plurality of location update requests sent from individual ones of the plurality of idle state user nodes in response to receiving the location update-related information; sending a first message from the relay node to the network access node, the first message comprising the aggregated plurality of location update requests; determining at the network access node a corresponding plurality of user node location update responses; sending a second message from the network access node to the relay node, the second message comprising aggregated user node location update responses and receiving the second message and sending from the relay node individual ones of the aggregated user node location update responses to corresponding individual ones of the user nodes.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 shows an exemplary usage scenario of a RS.

FIG. 2 is a message flow diagram that illustrates the operations that occur during use of an optimized location update procedure in accordance with exemplary embodiments of this invention.

FIG. 3 is a message flow diagram that illustrates the operations that occur during transfer of paging information from the BS to the RS, and also shows an alternative where this information is obtained by the RS by snooping messages sent from the base station to the mobile stations.

FIG. 4 is a block diagram that shows in greater detail the RS, BS and MSs of FIG. 1, and that also shows exemplary message flows in accordance with FIG. 2.

FIG. 5 shows an example of PGs in a cellular system and an exemplary path taken by the mobile RS through different PG areas.

### DETAILED DESCRIPTION

The exemplary embodiments of this invention solve at least the problem discussed above related to a mobile RS by providing a signaling-optimized location update procedure.

The exemplary embodiments of this invention relate generally to mobile multi-hop RS by providing a signaling-optimized location update procedure when the RS is mobile (e.g., associated with a mobile platform). An exemplary, but non-limiting embodiment, is described in the context of IEEE 802.16 technology (WiMAX).

Of interest to the ensuing discussion of the exemplary embodiments of this invention is IEEE Std 802.16e™-2005 and IEEE Std 802.16™-2004/Cor1-2005, such as pages 1-268 which discuss in part the DCD message, sleep mode, idle mode and location update operations. At least this portion of IEEE Std 802.16e™-2005 and IEEE Std 802.16™-2004/Cor1-2005 is incorporated by reference herein.

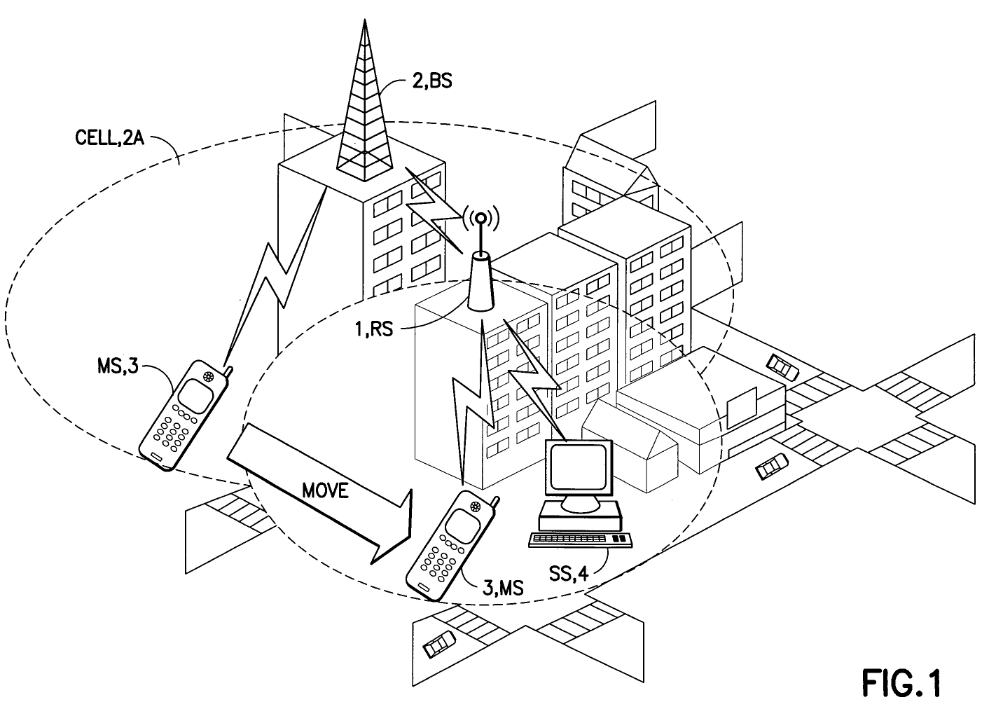

FIG. 1 shows an exemplary usage scenario of a RS 1 (or relay node) that is wirelessly interposed between a BS 2 (which may be construed generally to be a network access node), having an associated cell 2A, and a MS 3 and a SS 4. Note in this example that the MS 3 (which may be construed generally to be a user node, as may the SS 4) is originally located within the cell 2A, and thus communicates directly with the BS 2. Due to movement of the MS 3 it finds itself outside of the cell boundary, and at this time is coupled to the BS 2 via the RS 1. The SS 4, which can be assumed for this non-limiting example to be a desktop or similar type of computing device, is considered to be stationary or relatively stationary at a location outside of the cell boundary, and thus is persistently coupled to the BS 2 via the RS 1. For the purposes of explaining the exemplary embodiments of this invention it is assumed that the RS 1 is also mobile and is capable of moving from one Paging Group to another. It is further assumed that the RS 1 and the BS 2 are constructed so as to operate in accordance with the exemplary embodiments of this invention, as described in detail below.

Note that various embodiments of the MS/SS 3,4 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

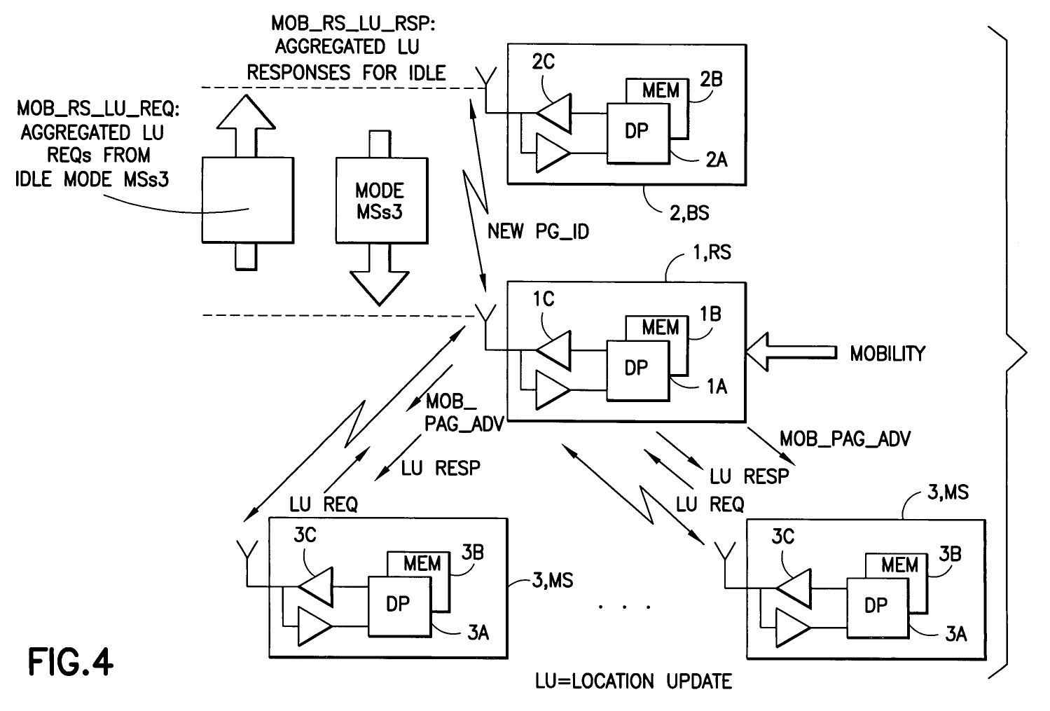

Referring also briefly to FIG. 4, the exemplary embodiments of this invention may be implemented by computer software executable by a data processor (DP 1A) of the RS 1 and a DP 2A of the BS 2, or by hardware, or by a combination of software and hardware. If one assumes that the RS 1 and BS 2 include a memory device or system (MEM 1B, 2B) that stores the applicable software program(s), then the memory may be of any type suitable to the local technical environment and may be implemented using any suitable data storage technology, such as semiconductor-based memory devices, magnetic memory devices and systems, optical memory devices and systems, fixed memory and removable memory. The DPs of the RS 1 and the BS 2 may also be of any type suitable to the local technical environment, and may include one or more of general purpose computers, special purpose computers, microprocessors, digital signal processors (DSPs) and processors based on a multi-core processor architecture, as non-limiting examples. The RS 1 is assumed to include at least one wireless transceiver 1C, and the BS 2 is also assumed to include at least one wireless transceiver 2C.

It may be assumed that the MSs 3 (and also SSs 4) are similarly constructed, as is also shown in FIG. 4.

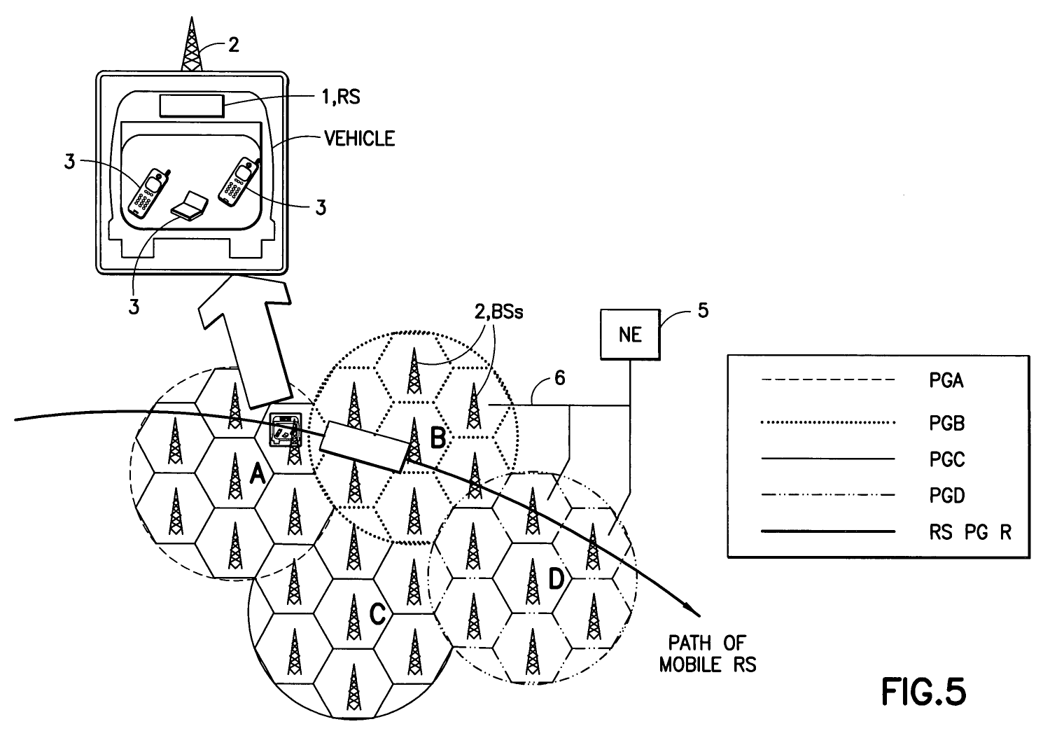

FIG. 5 represents a non-limiting example of the assignment of a PG in the cellular network. The “arc” shows the path of the mobile RS 1 though the various cells. All of the BSs 2 transmit their PG list in a broadcast message. BSs 2 in PG area A transmit a PG list containing PG A, similarly BSs 2 in PG area B transmit a PG list that contains PG B, and so on. The assignment of the PG is controlled by some network entity (NE) such as the PC 5 that is coupled via a network backbone, depicted as the link 6, and a given BS 2 may belong to more than one PG. Note in this example that the RS 1 is shown as being installed aboard a vehicle, e.g., a city bus, and provides coverage for a plurality of different types of MSs 3 that are carried and used by passengers.

The exemplary embodiments of this invention provide an efficient procedure for performing a MS 3 location update while the MS 3 is attached to the BS 2 via the RS 1. When the RS 1 moves from one location area (defined by a Paging Group) to another location area (and all attached idle MSs “move” along with the RS 1), the RS 1 generates and schedules a MOB_PAG ADV (Mobile Paging Advertisement) message for all of the idle MSs 3 attached to it and provides a unicast LU allocation for each of the MSs 3 attached to it. Each MS 3 performs network entry for the location update in a co-ordinated manner. The RS 1 aggregates location update parameters of all of the idle MSs 3 and exchanges information with the BS 2 (in a new paging group area) in a single UL message for initiating the location update. The BS 2, or any other network element (e.g. PC), updates the locations of all of the MSs 3 (attached to the RS 1) and sends one single DL message to the RS 1 in which it provide the location update response for all of the MSs 3. The RS 1 sends the location update response individually to each of the MSs 3.

Note that by use of this procedure the required messaging between the BS 2 and the RS 1 can be significantly reduced for a case where there are two or more MSs 3 attached to the RS 1. The use of the exemplary embodiments of this invention thus reduces the signaling load on the BS-RS link, and also congestion on the RS-MS link.

More specifically, when the RS 1 moves from one PG to another PG (the RS 1 identifies the change in the PG by monitoring a broadcast message from the BS 2) it generates and schedules MOB_PAG_ADV messages according to a PAGING_CYCLE and PAGING_OFFSET of the various ones of the attached MSs 3. In the same MOB_PAG_ADV, or via a UNICAST UL_ALLOCATION, it also schedules a UNICAST ranging opportunity to receive location update request messages from all of the attached IDLE MSs 3. This avoids contention on the RS-MS link.

To schedule MOB_PAG_ADV message and UNICAST Ranging allocation and UL ranging opportunity for the attached MSs 3 the RS 1 may, for example, preempt other low priority traffic or request resources from the BS 2. Also RS 1 also sends a bandwidth request to the BS 2 for sending a newly defined message referred to herein as a MOB_RS_LU_REQ. The RS 1 may use the existing mechanism defined in 802.16 to request the bandwidth.

The RS 1 collects the location update requests (LU REQs) from all the MSs 3 and sends the aggregated location update request to the BS 2 in one message. This improves the spectral efficiency on the BS-RS link. The BS 2 also transmits an aggregated location update response in one (newly defined) message to the RS 1. The RS 1 generates the individual MS-specific LU responses from the aggregated LU response received from the BS 2 and sends them each MS 3 individually.

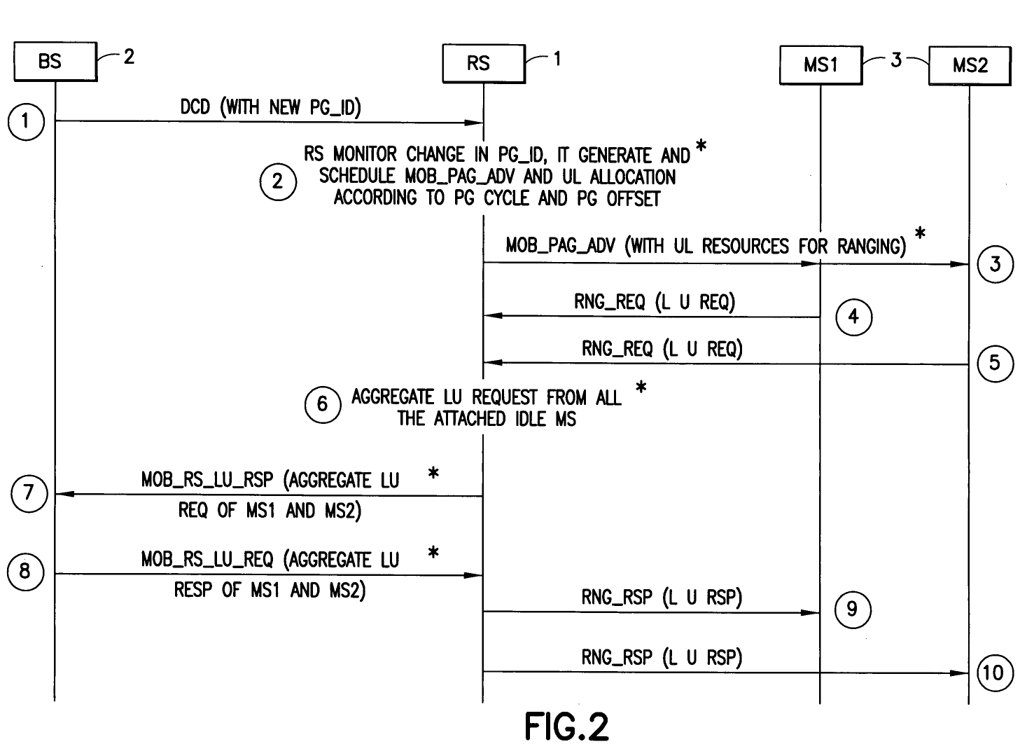

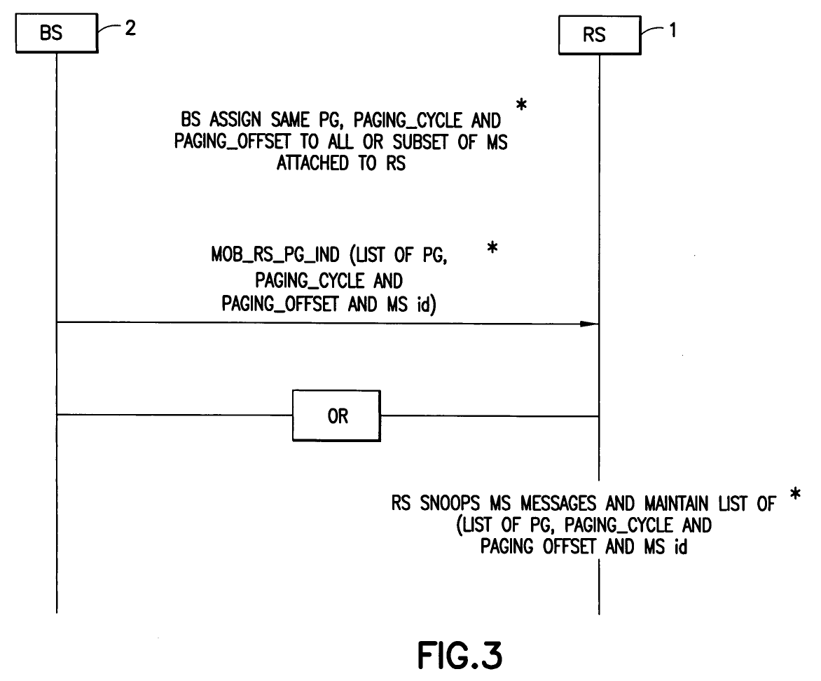

FIG. 2 is a message flow diagram that illustrates the operations that occur during use of an optimized location update procedure in accordance with exemplary embodiments of this invention. In FIG. 2 (and in FIG. 3 described below) those messages and operations that are provided in accordance with the exemplary embodiments of this invention are indicated with an asterisk (*). FIG. 2 also shows the presence of two MSs 3, although more than two may be present and connected to the RS 1 at any given instant.

Reference may also be made to FIG. 4 during the ensuing description of FIG. 2.

At Step 1 the RS 1 receives a new PG_ID in a DCD from the BS 2, indicating that due to mobility of the RS 1 that it has entered a new PG. At Step 2, and in accordance with an aspect of the exemplary embodiments of this invention, the RS 1 generates and schedules MOB_PAG_ADV and UL allocations for the MS 3 according to their respective PG CYCLEs and PG OFFSETs, and transmits them to the MSs 3 at Step 3. At Steps 4 and 5 the MSs 3 are assumed to transmit their respective RNG_REQ Location Update (LU) messages to the RS 1. At Step 6, and in accordance with a further aspect of the exemplary embodiments of this invention, the RS 1 receives and aggregates the various RNG_REQ LU messages from the population of idle mode MSs 3, and at Step 7 transmits the aggregated RNG_REQ LU messages as part of a MOB_RS_LU_REQ message to the BS 2. This is a newly defined message in accordance with the exemplary embodiments of this invention, to which the BS 2 responds at Step 8 by transmitting the newly defined MOB_RS_LU_RSP message to the RS 1. The MOB_RS_LU_RSP message is an aggregated Location Update response to individual ones of the MSs 3. At Step 9 the RS 1 de-aggregates the Location Update responses from the received MOB_RS_LU_RSP message and transmits them individually to the MSs 3. The required bandwidth. for transmission of the Location Update response to individual ones of the MSs 3 is either coordinated with the BS 2 or scheduled by the RS 1.

It should be noted that in FIG. 2 the MSs 3 need not be modified to accommodate the newly defined signaling between the RS 1 and the BS 2. That is, the MSs 3 may operate in a normal fashion, and may not be aware of the details, or even the occurrence, of the newly defined operations and signaling taking place between the RS 1 and the BS 2. It should be noted that it is possible that different MSs 3 attached via the RS 1 could have different PAGING_CYCLE and PAGING_OFFSET parameters. In this case the RS 1 may schedule multiple MOB_PAG_ADV messages according to the different MS PAGING_CYCLE and PAGING_OFFSET requirements of the MSs 3. The RS 1 may be apprised of this information by it being explicitly transferred from the BS 2 to the RS 1 or, alternatively, the RS 1 may “snoop” those messages sent to the MSs 3 by the BS 2 where the PAGING_GROUP, PAGING_CYCLE and PAGING_OFFSET messages are transferred, and record this information for subsequent use.

That is, and referring to FIG. 3, in order to reduce the number of MOB_PAG_ADV messages generated by RS 1, the BS 2 or some other entity such as a Paging Controller (PC) in the network may assign one PAGING_GROUP, PAGING_CYCLE and PAGING_OFFSET to all MSs 3, or to some subset of MSs 3, attached to the RS 1 (Step 1). The BS 2 then transfers at Step 2 this information to the RS in a separate message, in conjunction with the associated MS 3 identifications (IDs). Alternatively, the RS 1 may snoop messages sent to the MSs 3 by the BS 2 and maintain a list of the PAGING_GROUP, PAGING_CYCLE and PAGING_OFFSET parameters, in conjunction with the associated MS IDs.

It should be appreciated that a number of advantages can be gained by the use of the exemplary embodiments of this invention including, but not limited to, no change is required in the MS 3 implementation, spectrally efficient signaling is provided, there is reduced congestion on the BS-RS and RS-MS links, and the overall latency for the MS location update, via the RS 1, can be reduced.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, message flow diagrams, or using some other pictorial representation, it is well understood that these blocks, apparatus, systems, techniques and/or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations may become apparent to those skilled in the relevant arts in view of the foregoing description, when read in conjunction with the accompanying drawings and the appended claims. As but some examples, the use of other similar or equivalent message formats, types and names may be attempted by those skilled in the art. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
operating a relay node to receive individual ones of a plurality of request messages destined for a network access node from individual ones of a plurality of user nodes;
aggregating the received individual ones of the plurality of request messages into a single message at the relay node; and
sending the single message to the network access node.

2. The method of claim 1, further comprising:
further operating the relay node to receive from the network access node a single message that comprises an aggregated plurality of response messages for individual ones of the user nodes; and
sending individual ones of the response messages to individual ones of the user nodes.

3. The method of claim 2, where the request messages are location update request messages, and where the response messages are location update response messages.

4. The method of claim 1, comprising initial steps of:
detecting a change of paging group of the relay node due to mobility; and
in response, sending a mobile paging advertisement message (MOB_PAG_ADV) from the relay node to the plurality of user nodes, where the plurality of request messages are sent in response from at least some user nodes receiving the MOB_PAG_ADV message.

5. The method of claim 4, where at least some of the plurality of user nodes have differing PAGING_CYCLE and PAGING_OFFSET parameters, and where the relay node schedules a plurality of MOB_PAG_ADV messages according to the differing PAGING_CYCLE and PAGING_OFFSET requirements of the user nodes.

6. The method of claim 5, where the relay node gains knowledge of the differing PAGING_CYCLE and PAGING_OFFSET parameters by being explicitly informed of these parameters by the network access node.

7. The method of claim 5, where the relay node gains knowledge of the differing PAGING_CYCLE and PAGING_OFFSET parameters by snooping messages sent to the plurality of user nodes by the network access node.

8. A computer program product embodied on a computer readable medium and comprising program instructions the execution of which by a data processor of a relay node result in operations that comprise:
receiving individual ones of a plurality of request messages destined for a network access node from individual ones of a plurality of user nodes;
aggregating the received individual ones of the plurality of request messages into a single message at the relay node; and
sending the single message to the network access node.

9. The computer program product of claim 8, further comprising:
operating the relay node to receive from the network access node a single message that comprises an aggregated plurality of response messages for individual ones of the user nodes; and
sending individual ones of the response messages to individual ones of the user nodes.

10. The computer program product of claim 9, where the request messages are location update request messages, and where the response messages are location update response messages.

11. The computer program product of claim 8, comprising initial operations of:
detecting a change of paging group of the relay node due to mobility; and
in response, sending a mobile paging advertisement message (MOB_PAG_ADV) from the relay node to the plurality of user nodes, where the plurality of request messages are sent in response from at least some user nodes receiving the MOB_PAG_ADV message.

12. The computer program product of claim 11, where at least some of the plurality of user nodes have differing PAGING_CYCLE and PAGING_OFFSET parameters, and where the relay node schedules a plurality of MOB_PAG_ADV messages according to the differing PAGING_CYCLE and PAGING_OFFSET requirements of the user nodes.

13. The computer program product of claim 12, where the relay node gains knowledge of the differing PAGING_CYCLE and PAGING_OFFSET parameters by being explicitly informed of these parameters by the network access node.

14. The computer program product of claim 12, where the relay node gains knowledge of the differing PAGING_CYCLE and PAGING_OFFSET parameters by snooping messages sent to the plurality of user nodes by the network access node.

15. A relay node, comprising:
at least one wireless transceiver to conduct communications with a network access node and with user nodes; and
a control unit coupled to the wireless transceiver and operable to receive individual ones of a plurality of request messages destined for the network access node from individual ones of a plurality of user nodes, to aggregate the received individual ones of the plurality of request messages into a single message and to transmit the single message to the network access node.

16. The relay node of claim 15, said control unit further operable to receive from the network access node a single message that comprises an aggregated plurality of response messages for individual ones of the user nodes and to transmit individual ones of the response messages to individual ones of the user nodes.

17. The relay node of claim 16, where the request messages are location update request messages, and where the response messages are location update response messages.

18. The relay node of claim 15, said control unit further operable to detect a change of paging group due to mobility and, in response, to transmit a mobile paging advertisement message (MOB_PAG_ADV) to the plurality of user nodes, where the plurality of request messages are transmitted to the relay node in response to at least some user nodes receiving the MOB_PAG_ADV message.

19. The relay node of claim 18, where at least some of the plurality of user nodes have differing PAGING_CYCLE and PAGING_OFFSET parameters, and where said control unit schedules a plurality of MOB_PAG_ADV messages according to the differing PAGING_CYCLE and PAGING_OFFSET requirements of the user nodes.

20. The relay node of claim 19, where the control unit gains knowledge of the differing PAGING_CYCLE and PAGING_OFFSET parameters by being explicitly informed of these parameters by a transmission received from the network access node.

21. The relay node of claim 19, where the relay node gains knowledge of the differing PAGING_CYCLE and PAGING_OFFSET parameters by snooping messages transmitted to the plurality of user nodes by the network access node, the messages being received at said relay node and transmitted to the plurality of user nodes.

22. A method, comprising:
operating a network access node to receive a message from a relay node, the message comprising a plurality of request messages destined for a network access node that are sent individually from individual ones of a plurality of user nodes; and
in response, aggregating a plurality of response messages for individual ones of the user nodes and sending the aggregated plurality of response messages in a single message to the relay node.

23. The method of claim 22, where the request messages are location update request messages, and where the response messages are location update response messages.

24. The method of claim 22, further comprising assigning a plurality of the mobile nodes the same PAGING_CYCLE and PAGING_OFFSET parameters.

25. A computer program product embodied on a computer readable medium and comprising program instructions the execution of which by a data processor of a network access node result in operations that comprise:
receiving a message from a relay node, the message comprising a plurality of request messages destined for the network access node that are sent individually from individual ones of a plurality of user nodes; and
in response, aggregating a plurality of response messages for individual ones of the user nodes and sending the aggregated plurality of response messages in a single message to the relay node.

26. The computer program product of claim 25, where the request messages are location update request messages, and where the response messages are location update response messages.

27. The computer program product of claim 25, further comprising assigning a plurality of the mobile nodes the same PAGING_CYCLE and PAGING_OFFSET parameters.

28. A network access node, comprising:
at least one wireless transceiver to conduct communications with a relay node that is wirelessly coupled to a plurality of user nodes; and
a control unit coupled to the wireless transceiver and operable to receive a message transmitted from the relay node, the message comprising a plurality of request messages destined for the network access node that are transmitted individually from individual ones of the plurality of user nodes and, in response, to aggregate a plurality of response messages for individual ones of the user nodes and to transmit the aggregated plurality of response messages in a single message to the relay node.

29. The network access node of claim 28, where the request messages are location update request messages, and where the response messages are location update response messages.

30. The network access node of claim 28, said control unit further operable to assign a plurality of the mobile nodes the same PAGING_CYCLE and PAGING_OFFSET parameters.

31. A method, comprising:
detecting at a relay node a change in location due to mobility of the relay node relative to at least one network access node;
in response, sending location update-related information to a plurality of attached idle state user nodes;
receiving and aggregating at the relay node a plurality of location update requests sent from individual ones of the plurality of idle state user nodes in response to receiving the location update-related information;
sending a first message from the relay node to the network access node, the first message comprising the aggregated plurality of location update requests;
determining at the network access node a corresponding plurality of user node location update responses;
sending a second message from the network access node to the relay node, the second message comprising aggregated user node location update responses; and
receiving the second message and sending from the relay node individual ones of the aggregated user node location update responses to corresponding individual ones of the user nodes.

32. The method of claim 31, where detecting comprises receiving an identification of a new paging group from the network access node.

33. The method of claim 31, where the location update-related information comprises a mobile paging advertisement (MOB_PAG_ADV) message.

34. The method of claim 33, where at least some of the plurality of idle state user nodes have differing PAGING_CYCLE and PAGING_OFFSET parameters, and where the relay node schedules a plurality of MOB_PAG_ADV messages according to the differing PAGING_CYCLE and PAGING_OFFSET requirements of the user nodes.

35. The method of claim 34, where the relay node gains knowledge of the differing PAGING_CYCLE and PAGING_OFFSET parameters by one of being explicitly informed of these parameters by the network access node, and snooping messages sent to the plurality of user nodes by the network access node.
